(19) United States
(12) Patent Application Publication
(10) Pub. No.: US 2022/0210578 A1
(43) Pub. Date: Jun. 30, 2022

(54) AUDIO REPRODUCTION APPARATUS AND AUDIO DEVICE

(71) Applicant: Sony Group Corporation, Tokyo (JP)

(72) Inventors: Toshiyuki Nakagawa, Kanagawa (JP); Yoshio Ohashi, Kanagawa (JP)

(73) Assignee: Sony Group Corporation, Tokyo (JP)

(21) Appl. No.: 17/613,008

(22) PCT Filed: Apr. 3, 2020
(86) PCT No.: PCT/JP2020/015307

§ 371 Date: Nov. 19, 2021

(30) Foreign Application Priority Data
May 27, 2019 (JP) 2019-098438

(51) Int. Cl. H04R 17/00; H04R 1/02

(52) U.S. Cl. CPC H04R 17/005; H04R 2217/03; H04R 1/026

(57) ABSTRACT

An audio reproduction apparatus includes an audio device in which a plurality of layer structures is formed by folding a thin film material having a capacitance layer sandwiched between a first electrode layer and a second electrode layer a plurality of times, and a vibrated portion which is bendable and to which one face of the audio device is fixed.

### TECHNICAL FIELD

The present disclosure relates to an audio reproduction apparatus and an audio device.

### BACKGROUND ART

As one of audio devices, an audio device using a piezoelectric material is known. Patent Document 1 and Patent Document 2 disclose audio devices using such piezoelectric materials.

### CITATION LIST

### Patent Document

Patent Document 1: Japanese Patent Application Laid-Open No. S59-158199

### Patent Document 2: Japanese Patent Application Laid-Open No. 2011-97181

### SUMMARY OF THE INVENTION

### Problems to be Solved by the Invention

In such a field, it is desired to realize suitable acoustic characteristics.

### Solutions to Problems

The present disclosure is, for example, an audio reproduction apparatus including:

an audio device in which a plurality of layer structures is formed by folding a thin film material including a first electrode layer, a second electrode layer, and a capacitance layer sandwiched between the first electrode layer and the second electrode layer a plurality of times; and

a vibrated portion which is bendable and to which one face of the audio device is fixed.

The present disclosure is, for example, an audio device, in which

a thin film material including a first electrode layer, a second electrode layer, and a capacitance layer sandwiched between the first electrode layer and the second electrode layer is folded a plurality of times to form a plurality of layer structures, and one face of the audio device is fixed to a vibrated portion which is bendable.

### BRIEF DESCRIPTION OF DRAWINGS

FIG. 1 is a diagram for explaining a principle of a piezoelectric element.

FIG. 2 is a diagram showing a configuration example of an audio reproduction apparatus.

FIGS. 3(A) to 3(D) are diagrams showing one example of a manufacturing process and a structure of an audio device.

FIG. 4 is a flowchart showing one example of the manufacturing process of the audio device.

FIGS. 5(A) and 5(B) are diagrams showing one example of frequency characteristics of the audio reproduction apparatus.

FIGS. 6(A) and 6(B) are diagrams showing one example of frequency characteristics of the audio reproduction apparatus.

FIGS. 7(A) and 7(B) are diagrams showing one example of frequency characteristics of the audio reproduction apparatus.

FIGS. 8(A) and 8(B) are diagrams showing one example of frequency characteristics of the audio reproduction apparatus.

FIGS. 9(A) to 9(D) are diagrams showing one example of a manufacturing process and a structure of an audio device.

FIGS. 10(A) to 10(D) are diagrams showing one example of a manufacturing process and a structure of an audio device.

FIGS. 11(A) to 11(D) are diagrams showing one example of a manufacturing process and a structure of an audio device.

FIGS. 12(A) to 12(D) are diagrams showing one example of a manufacturing process and a structure of an audio device.

FIG. 13 is a diagram 13 showing a modification example of the audio reproduction apparatus.

### MODE FOR CARRYING OUT THE INVENTION

Hereinafter, embodiments and the like of the present disclosure will be described with reference to the drawings. Note that the description will be given in the following order.

<1. Description of Principle of Piezoelectric Element>

<2. First Embodiment>

<3. Frequency Characteristics Comparison 1>

<4. Frequency Characteristics Comparison 2>

<5. Second Embodiment>

<6. Third Embodiment>

<7. Fourth Embodiment>

<8. Fifth Embodiment>

<9. Modification Example>

The embodiments and the like described below are suitable specific examples of the present disclosure, and the contents of the present disclosure are not limited to these embodiments and the like.

### 1. Description of Principle of Piezoelectric Element

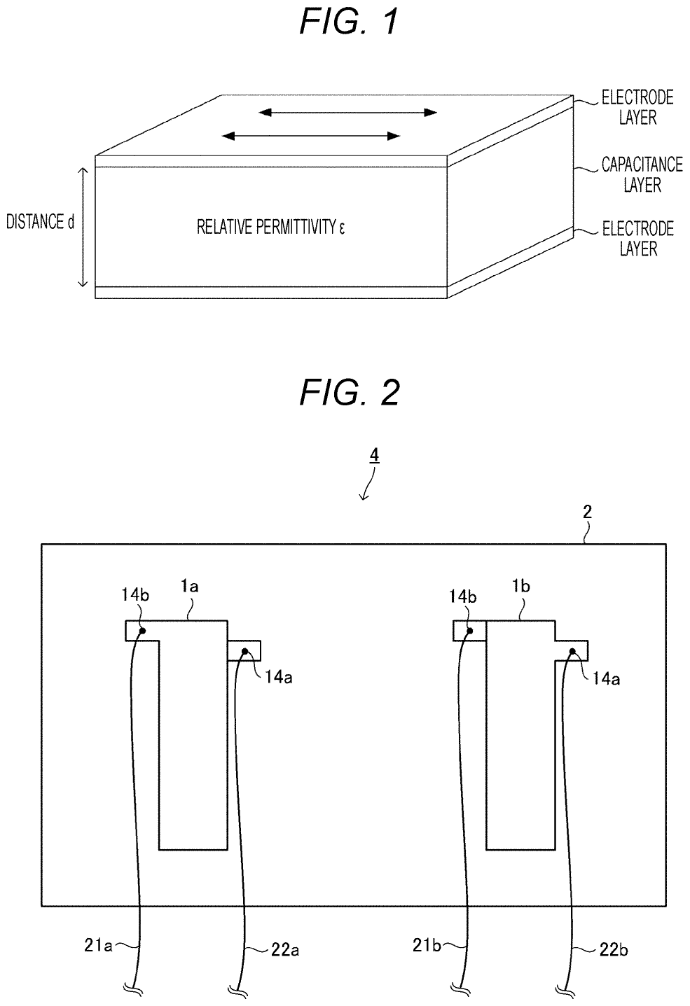

FIG. 1 is a diagram for explaining a principle of a piezoelectric element. The piezoelectric element has a structure in which a capacitance layer is sandwiched between two electrode layers. When a voltage is applied to the electrode layers, displacement occurs in a direction of the arrow shown in FIG. 1. The audio reproduction apparatus according to the present embodiment functions as a so-called speaker by converting a displacement amount of the piezoelectric element into vibration of air.

When the relative permittivity ε of a dielectric constituting the capacitance layer, the distance d between the electrodes, and the area S of the electrodes are defined as the capacitance C of the piezoelectric element, the following relationship is established.

C=εS/d

In addition, since the relationship between the capacitance C of the piezoelectric element and the magnitude of the impedance Z is a reciprocal relationship, the impedance Z decreases as the capacitance C increases. Therefore, an increase in the capacitance C indicates that the sensitivity to voltage is improved, that is, the larger the capacitance C, the easier to obtain a large sound pressure as an audio reproduction apparatus.

Moreover, the charge Q stored in the piezoelectric element is a product of the voltage V applied to the piezoelectric element and the capacitance C, that is,

Q=CV.

Therefore, in order to store the same amount of charge Q, the required voltage V can be reduced as the capacitance increases, and the voltage V for obtaining the required sound pressure can be reduced.

Herein, as for the vibration in the length direction, the displacement amount ΔL generated when the voltage V is applied between the electrode layers is given as follows in a case where d is a distance between the electrode layers.

ΔL=a*V*L/d

Herein, a is a piezoelectric strain constant and is a strain generated when a unit electric field is applied in a state of zero stress. Therefore, in order to obtain a larger displacement amount ΔL, it is found that the distance d between the electrode layers is small, that is, a thin film is preferable.

The audio reproduction apparatus according to the present embodiment uses an audio device formed using a thin film-shaped piezoelectric element (thin film material). This audio device has a sheet shape having plasticity, and expands and contracts in a plane direction of the sheet as shown in FIG. 1 when a voltage is applied. By converting this expansion and contraction into vibration of air, it becomes possible to use it for an audio reproduction apparatus.

### 2. First Embodiment

FIG. 2 shows the configuration of an audio reproduction apparatus 4. The audio reproduction apparatus 4 includes two audio devices 1a and 1b and a vibrated portion 2. The vibrated portion 2 is, for example, a member having plasticity, and includes a material harder than the audio devices 1a and 1b. The vibrated portion 2 converts vibration of the audio devices 1a and 1b into vibration of air and emits sound. The vibrated portion 2 of the present embodiment has a planar shape, but may have a curved shape. The substantially entire surfaces of the audio devices 1a and 1b are fixed to the vibrated portion 2 using an adhesive. As described above, by bringing substantially the entire surfaces of the audio devices 1a and 1b into close contact with the vibrated portion 2, the sound conversion efficiency is improved.

The audio reproduction apparatus 4 can form a display panel capable of emitting sound, for example, by using a thin display panel such as a liquid crystal display panel, an organic EL, an electrophoretic type or a twist-ball type thin for the vibrated portion 2, and fixing the audio devices 1a and 1b to the back surface of the thin display panel. As described above, the audio reproduction apparatus 4 may have both the display function and the sound emission function, or the vibrated portion 2 may be used like a diaphragm of a speaker and may have only the sound emission function.

The audio device 1a has electrode portions 14a and 14b, and signal lines 21a and 22a are connected to the electrode portions 14a and 14b, respectively. By inputting an acoustic signal into the signal lines 21a and 22a, it is possible to vibrate the audio device 1a and emit sound via the vibrated portion 2. The same applies to the audio device 1b, and an acoustic signal is inputted into the signal lines 21b and 22b. Stereo reproduction can be realized by inputting left and right audio signals to the audio devices 1a and 1b, respectively.

As described in FIG. 1, the displacement caused by voltage application to the piezoelectric element is a direction parallel to a surface of the piezoelectric element as indicated by an arrow, and cannot be converted into air vibration as it is. The audio devices 1a and 1b of the present embodiment are formed by folding a piezoelectric sheet 11, and can vibrate in a direction perpendicular to a plane in a state where the audio devices 1a and 1b and the vibrated portion 2 are integrated. In addition, since the folding is laminated in a plurality of layers, the sound emission efficiency is improved.

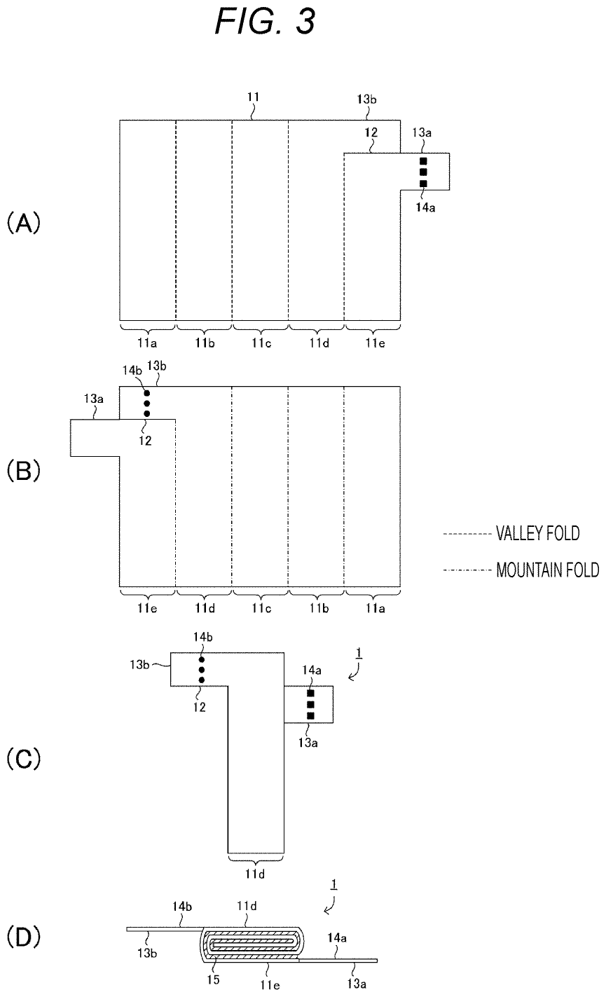

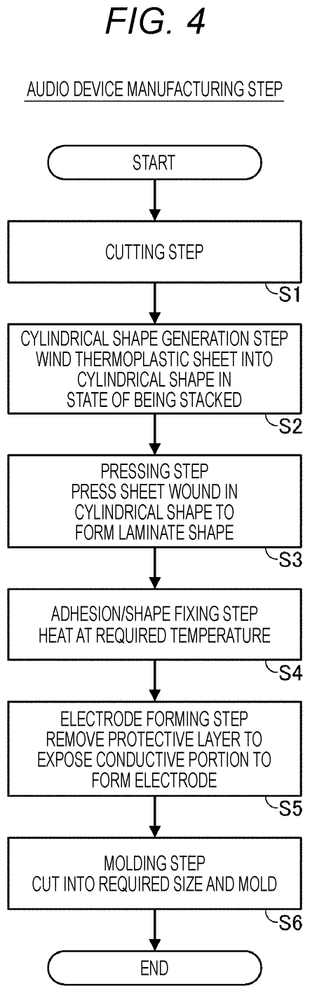

Now, manufacturing processes and structures of the audio devices 1a and 1b of the present embodiment will be described. Note that, in FIG. 2, since the two audio devices 1a and 1b are used, subscripts a and b are added, but the audio device 1 will be described below. FIG. 3 is a diagram showing a manufacturing process of the audio device 1. FIG. 4 is a flowchart showing a manufacturing process of the audio device 1.

The audio device 1 of the present embodiment is formed by folding a piezoelectric sheet (thin film material) and laminating the piezoelectric sheet 11 on a plurality of layers. As described in FIG. 1, the piezoelectric sheet 11 of the present embodiment has two electrode layers and a capacitance layer sandwiched between the electrode layers. The piezoelectric sheet 11 has a thickness of, for example, 30 μm to 100 μm and preferably has a thickness of 30 μm to 60 μm. In the present embodiment, a non-conductive protective layer including PET or the like is further provided on the surface layer side of the two electrode layers. Therefore, when the signal line is connected to the electrode layer, it is necessary to remove the protective layer at the connection portion to expose the electrode layer. Note that the piezoelectric sheet 11 is used in the present embodiment, but various materials such as an electrostatic sheet can be used in addition to the piezoelectric sheet 11 as long as the material is a thin film material having capacitive characteristics.

In the manufacturing process of the audio device 1, first, the piezoelectric sheet 11 to be a material is cut into the shapes of FIGS. 3(A) and 3(B) in the cutting step (S1). Note that FIG. 3(B) is a back surface of FIG. 3(A). In FIGS. 3(A) and 3(B), a portion indicated by a broken line is a portion that forms a valley fold when folded in a subsequent step, and a portion indicated by a one-dot chain line is a portion that forms a mountain fold. Regions 11a to 11e are regions separated by the broken line (alternatively, the one-dot chain line).

As shown in FIG. 3(A), the cut piezoelectric sheet 11 is provided with an extension portion 13a in a rightmost region 11e. Furthermore, a cut 12 is provided so as to be continuous with the upper side of the extension portion 13a. The cut 12 can be provided, and a portion located above the region 11e and continuous with the region 11d can be the extension portion 13b. Note that a portion where the region 11d and the extension portion 13b are connected is not folded. With such a configuration, when the piezoelectric sheet is folded, the electrode portion 14a provided at the extension portion 13a and the electrode portion 14b provided at the extension portion 13b face the same side as shown in FIG. 3(C). Note that FIGS. 3(A) and 3(B) show portions where the electrode portions 14a and 14b are provided. The electrode portions 14a and 14b are provided in a later step.

The piezoelectric sheet 11 cut into the shape of FIGS. 3(A) and 3(B) is wound in a cylindrical shape in a state where thermoplastic sheets are stacked (S2). Note that the thermoplastic sheet is disposed only in a region where the piezoelectric sheet 11 is stacked. Herein, as for the thermoplastic sheet, for example, it is conceivable to use a film-like hot-melt adhesive containing a thermoplastic elastomer resin as a main component. As a film-shaped hot-melt adhesive containing a thermoplastic elastomer resin as a main component, for example, ELFAN, ECERAN, and the like are known. Such a thermoplastic sheet has no adhesive force at room temperature, and thus is easy to process. In addition, since the thickness of the thermoplastic sheet is generally reduced after bonding, the thickness of the laminate is not significantly increased. By adjusting the thickness of the laminate, it is possible to adjust a sound pressure loss and a change in sound quality in the audio device 1. Note that, since the piezoelectric sheet 11 of the present embodiment is provided with a non-conductive protective layer including PET or the like on a surface layer thereof, a short circuit between electrode layers due to folding can be prevented. Therefore, the adhesive layer may be either conductive or non-conductive. Note that, in a case where the protective layer is not provided on the piezoelectric sheet 11, that is, in a case where the electrode layer is exposed in the piezoelectric sheet 11, the adhesive layer is required to have non-conductivity in order to prevent a short circuit between the electrode layers when folded.

The piezoelectric sheet 11 wound in a cylindrical shape and the thermoplastic sheet are pressed and folded in the pressing step (S3) to form a laminate shape. Thereafter, in the adhesion/shape fixing step (S4), the laminated sheet (piezoelectric sheet 11 and thermoplastic sheet) is heated at a temperature necessary for fusing the thermoplastic sheet. The heated thermoplastic sheet functions as an adhesive layer between the laminated piezoelectric sheets 11 by being heated.

After completion of the adhesion/shape fixing step (S4), an electrode forming step (S5) of forming the electrode portions 14a and 14b by removing the protective layer is executed. FIG. 3(C) is a front view of the audio device 1 at the time of completion of the manufacturing process, and FIG. 3(D) is a cross-sectional view of FIG. 3(C). Note that the cross-sectional view of FIG. 3(D) is schematically illustrated extending in the thickness direction in order to facilitate understanding of the layer structure.

In the present embodiment, as described with reference to FIGS. 3(A) and 3(B), the electrode portion 14a is formed at the extension portion 13a, and the other electrode portion 14b is formed at the extension portion 13b. Although it is necessary to form the electrode portions 14a and 14b on the front and back of the piezoelectric sheet 11, the piezoelectric sheet 11 of the present embodiment uses folding to expose the two electrode portions 14a and 14b to the same surface side. In addition, as shown in FIG. 3 (C), since the electrode portions 14a and 14b are disposed at positions not adjacent to each other, it is possible to suppress a short circuit between the electrode portions 14a and 14b at the time of wiring or the like. Moreover, the back surfaces of the extension portions 13a and 13b including the piezoelectric sheet 11 can also be fixed to the vibrated portion 2, and the area in which the audio device 1 is in close contact with the vibrated portion 2 is increased, thereby the acoustic conversion efficiency is also improved.

As shown in FIG. 3 (D), in the present embodiment, in the cylindrical shape generation step (S2) and the pressing step (S3), the piezoelectric sheet 11 and the thermoplastic sheet are wound in a cylindrical shape in a state of being stacked, and then pressed, so that the piezoelectric sheet 11 is wound in a spiral shape. Moreover, an adhesive layer 15 including a molten thermoplastic sheet is formed between the five layers of the regions 11a to 11e of the piezoelectric sheet 11. In the present embodiment, the piezoelectric sheet 11 is folded in this way, and in particular, the piezoelectric sheet 11 is bent, so that the bonded vibrated portion 2 is efficiently vibrated, and the acoustic conversion efficiency is improved.

As described with reference to FIG. 2, substantially the entire surface of the audio device 1 formed in such a process is fixed to the vibrated portion 2. In particular, in the present embodiment, the back surfaces of the extension portions 13a and 13b provided with the electrode portions 14a and 14b are also fixed to the vibrated portion 2, and the area where the audio device 1 is in close contact with the vibrated portion 2 is increased to improve the acoustic conversion efficiency.

### 3. Frequency Characteristics Comparison 1

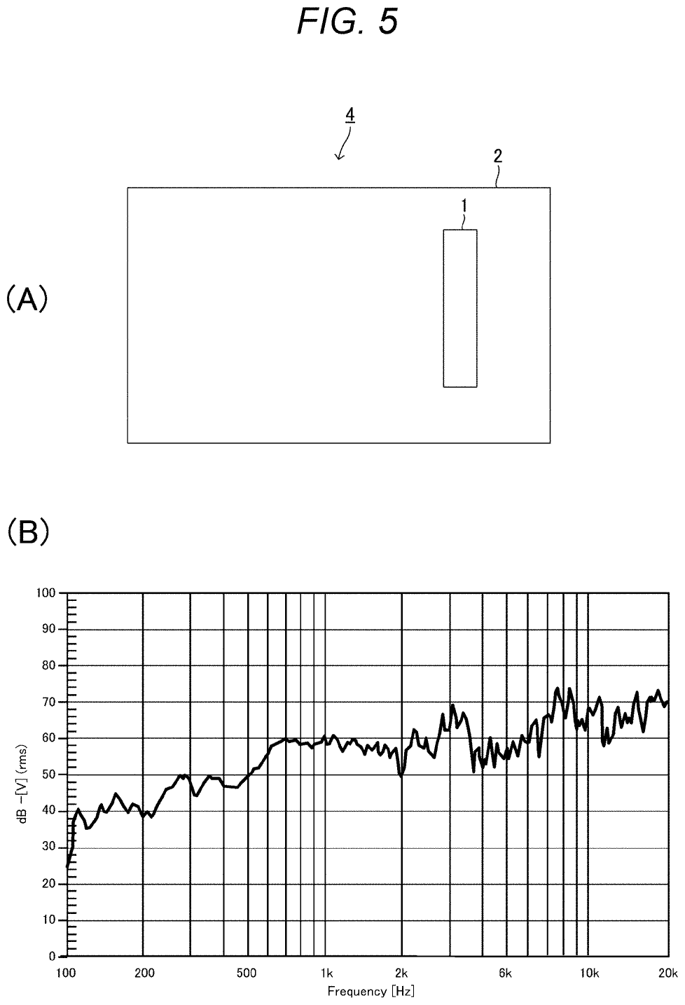

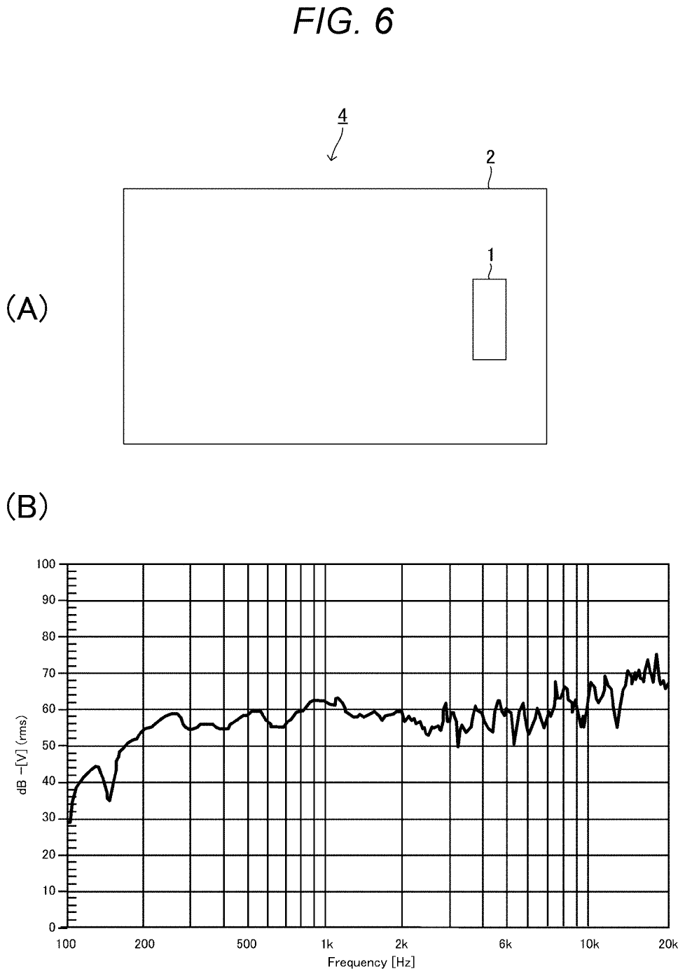

Next, frequency characteristics of the audio reproduction apparatus 4 using the audio device 1 according to various forms will be described. FIGS. 5 and 6 are diagrams showing a configuration and frequency characteristics of the audio reproduction apparatus 4. In FIGS. 5 and 6, the size of the audio device 1 to be used, the number of layers, and the like are made different, and changes in the frequency characteristics are observed.

As shown in FIG. 5(A), the audio reproduction apparatus 4 has a form in which the audio device 1 is adhered to the right side with respect to the center of the vibrated portion 2. The configuration of the audio device 1 has a three-layer structure with a long side (vertical) of 400 mm and a short side (horizontal) of 80 mm. Therefore, the area of the piezoelectric sheet 11 used in the audio device 1 of FIG. 5(A) is 0.096 m². FIG. 5(B) shows the frequency characteristics of the audio reproduction apparatus 4 of FIG. 5(A).

FIG. 6A is a diagram showing a configuration of the audio reproduction apparatus 4 to be compared. The audio reproduction apparatus 4 shown in FIG. 6(A) has a form in which the audio device 1 is adhered to the right side with respect to the center of the vibrated portion 2. The configuration of the audio device 1 has a 7-layer structure with a long side (vertical) of 100 mm and a short side (horizontal) of 50 mm. Therefore, the area of the piezoelectric sheet 11 used in the audio device 1 of FIG. 6(A) is 0.035 m². As described above, the audio device 1 used in FIG. 6(A) is smaller than the audio device 1 in FIG. 5(A), but has a structure with a large number of layers, that is, a structure with a large number of folds.

FIG. 6B shows the frequency characteristics of the audio reproduction apparatus 4 of FIG. 6(A). As can be seen from a comparison between the frequency characteristics of FIG. 5 (B) and the frequency characteristics of FIG. 6 (B), it can be confirmed that by adopting the structure with a large number of layers of FIG. 6(B), a sound pressure substantially similar to that of FIG. 6(B) is obtained although the area of the piezoelectric sheet 11 is about ⅓. In particular, it can be confirmed that the sound pressure is higher in 200 Hz to 1 kHz than in FIG. 5(B).

As described above, in the audio reproduction apparatus 4, by increasing the number of layers by folding the audio device 1, it is possible to improve acoustic characteristics and secure a necessary sound pressure.

### 4. Frequency Characteristics Comparison 2

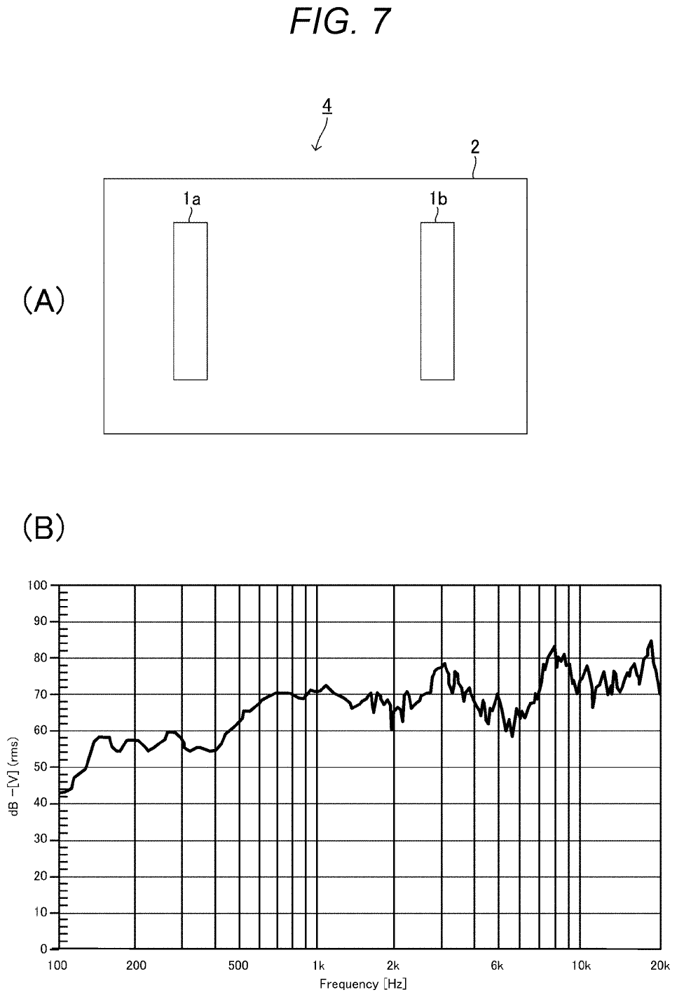

As shown in FIG. 7(A), in the audio reproduction apparatus 4, the audio devices 1a and 1b are bonded to the left side and the right side of the center of the vibrated portion 2, respectively. The configurations of the audio devices 1a and 1b have a three-layer structure with a long side (vertical) of 400 mm and a short side (horizontal) of 80 mm. FIG. 7(B) shows frequency characteristics of the audio reproduction apparatus 4 of FIG. 7(A).

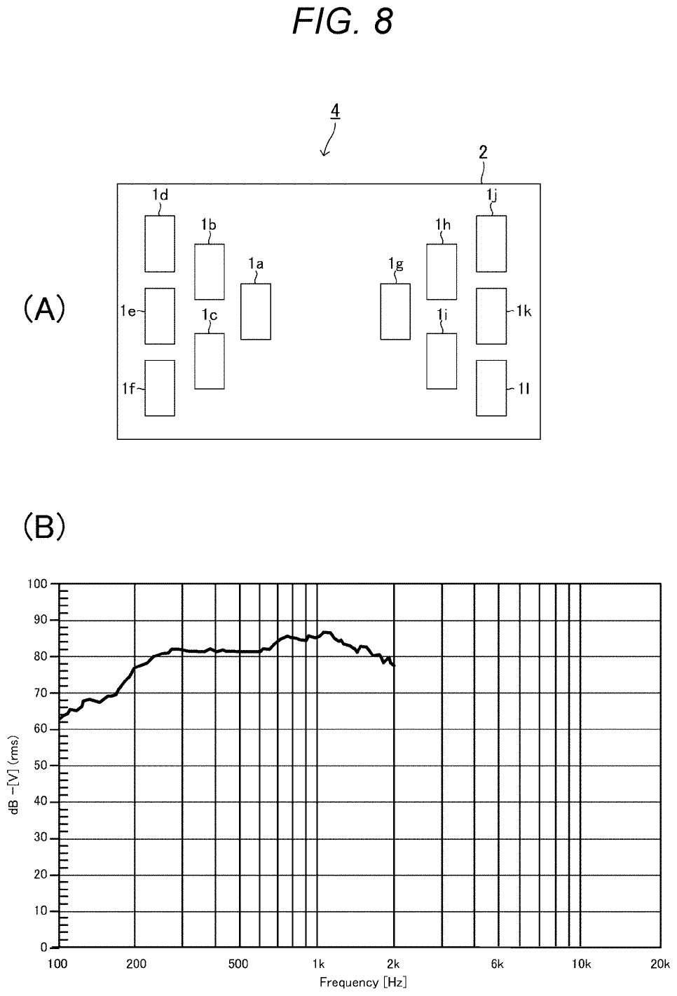

FIG. 8(A) is a diagram showing a configuration of the audio reproduction apparatus 4 to be compared. The audio reproduction apparatus 4 shown in FIG. 8(A) has a form in which six audio devices 1a to 1f are bonded to the left side with respect to the center of the vibrated portion 2. At this time, the number of audio devices 1a to 1f decreases from the left end toward the center. Moreover, six audio devices 1g to 1l are also bonded to the right side with respect to the center of the vibrated portion 2. The audio devices 1g to 1l disposed on the right side are disposed so as to be bilaterally symmetrical with the audio devices 1a to 1f disposed on the left side.

According to the disposition of the audio devices 1a to 1l as shown in FIG. 8(A), in a case where the audio devices 1a to 1f located on the left side are driven on the left channel and the audio devices 1g to 1l located on the right side are driven on the right channel, it is possible to improve the left-right separability. This is because, when the common vibrated portion 2 is vibrated, it is conceivable that interference between left and right acoustic signals might occur near the center of the vibrated portion 2, but interference on the vibrated portion 2 is suppressed by reducing the number of audio devices 1a and 1g disposed near the center.

The configurations of the audio devices 1a to 1l (12 sheets) used in FIG. 8(A) have a 7-layer structure with a long side (vertical) of 100 mm and a short side (horizontal) of 50 mm. FIG. 8(B) shows the frequency characteristics of the audio reproduction apparatus 4 of FIG. 8(A).

In the case of FIG. 7(A), each area of the piezoelectric sheets 11 used in the audio devices 1a and 1b is 0.096 m², and a total of 0.192 m² is obtained by using two piezoelectric sheets. On the other hand, in the case of FIG. 8(A), each area of the piezoelectric sheets 11 used in the audio devices 1a to 1l is 0.035 m², and the total area is 0.42 m² when 12 piezoelectric sheets are used. In the case of FIG. 8(A), the area is 2.2 times larger than that of FIG. 7 (A). However, in the area of 2.2 times in terms of calculation, the sound pressure is expected to increase by about 9 dB, and an improvement of 10 to 20 dB is observed depending on the frequency band.

As described above, in a case where the audio reproduction apparatus 4 is configured using a plurality of audio devices 1 in order to increase the sound pressure, increasing the total area of the piezoelectric sheet 11 in order to improve the sensitivity is consistent in principle, but it has been confirmed that the sound pressure is more efficiently improved with respect to the vibrated portion 2 by reducing the size of the audio device 1 and increasing the number of layers.

### 5. Second Embodiment

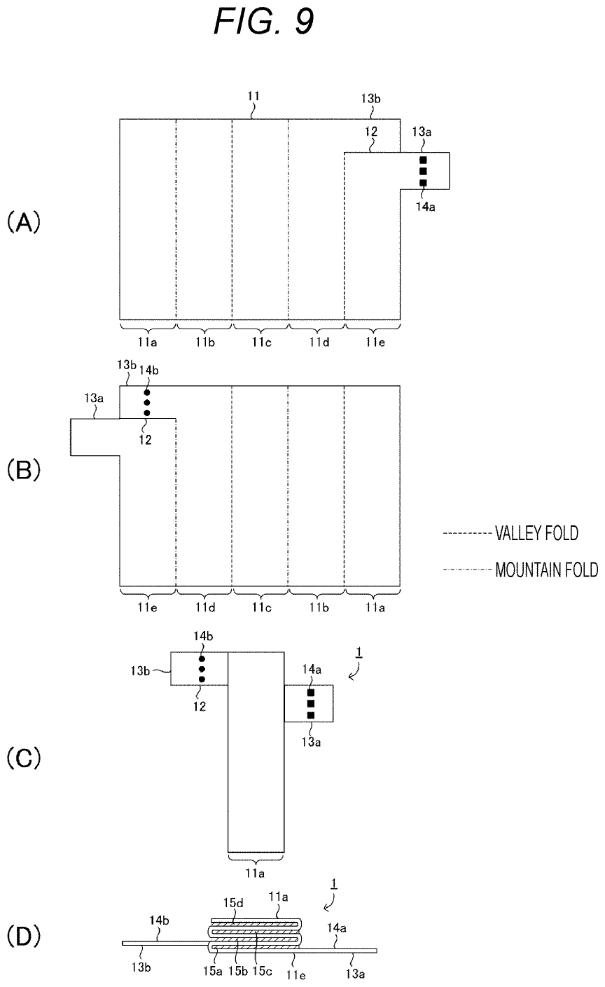

Although the structure of the audio device 1 of the first embodiment has been described with reference to FIG. 3, the audio device 1 can adopt various configurations. FIG. 9 is a diagram showing a manufacturing process and a structure of an audio device 1 according to the second embodiment.

As shown in FIGS. 9(A) and 9(B), a piezoelectric sheet 11 used in the audio device 1 is cut into the same shape as the audio device 1 described with reference to FIG. 3. The audio device 1 of FIG. 3 differs depending on the manner of lamination.

As can be seen from the mountain fold line and the valley fold line shown in FIGS. 9(A) and 9(B), in the audio device 1 of the second embodiment, the mountain fold and the valley fold are alternately arranged in the adjacent regions 11a to 11e. Therefore, the bent structure has a structure in which adjacent regions 11a to 11e are arranged in order to form a layer as shown in FIG. 9(D). In this case, four thermoplastic sheets to be used are used between the respective layers, and each of the thermoplastic sheets forms four adhesive layers 15a to 15d by fusing the respective layers.

Herein, with regard to the disposition of the thermoplastic sheet, even if the thermoplastic sheets are disposed on both sides serving as valley surfaces, the respective layers can be fused. For example, in FIG. 9(A), thermoplastic sheets may be disposed on both surfaces of 11b and 11c. Similarly, thermoplastic sheets may be disposed on both surfaces of 11d and 11e, 11d and 11c in FIG. 9 (B), and 11b and 11a. As described above, in a case where the audio reproduction apparatus 4 is configured using a plurality of audio devices 1 in order to increase the sound pressure, increasing the total area of the piezoelectric sheet 11 in order to improve the sensitivity is consistent in principle. However, by downsizing the audio device 1 and increasing the number of layers as shown in FIG. 9, the sound pressure can be more efficiently improved with respect to the vibrated portion 2.

### 6. Third Embodiment

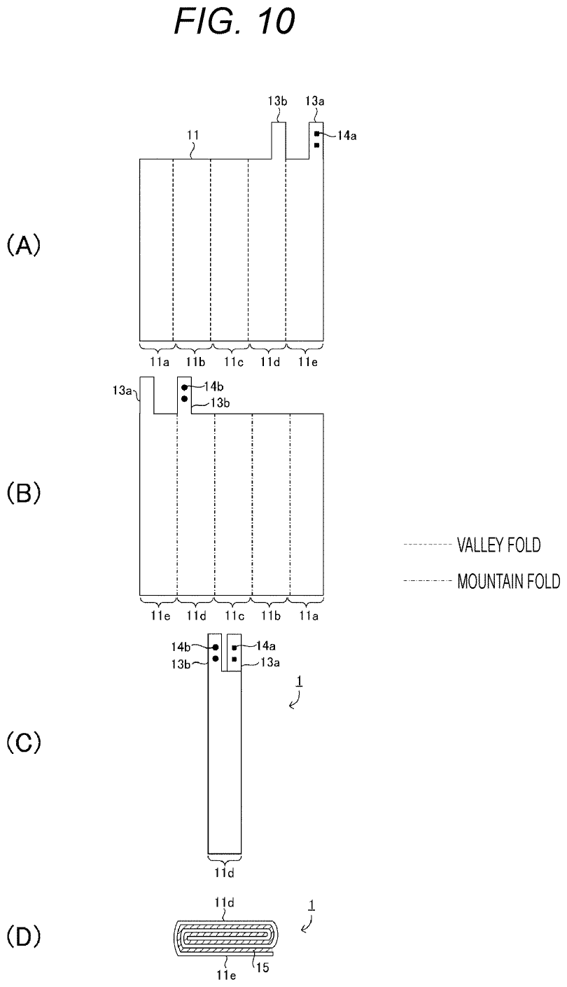

FIG. 10 is a diagram showing a manufacturing process and a structure of an audio device 1 according to a third embodiment. In the present embodiment, a piezoelectric sheet 11 is folded by being divided into five regions 11a to 11e, and all the folding methods are valley folds as shown in FIG. 10 (A). As a result, as shown in FIG. 10 (D), the piezoelectric sheet 11 is spirally wound similarly to the first embodiment.

Moreover, in the third embodiment, narrow extension portions 13b and 13a are provided in a region 11d and a region 11e. Then, an electrode portion 14a is formed on one surface of the extension portion 13a, and the electrode portion 14b is formed on the other surface of the extension portion 13b. By folding the piezoelectric sheet 11 in such a state, as shown in FIG. 10(C), it is possible to bring the piezoelectric sheet into a state of being adjacent to the extension portion 13a and the extension portion 13b with a space therebetween. Furthermore, in this state, the electrode portions 14a and 14b face the same side of the audio device 1. Therefore, it is easy to wire the signal lines to the electrode portions 14a and 14b and to route the signal lines.

### 7. Fourth Embodiment

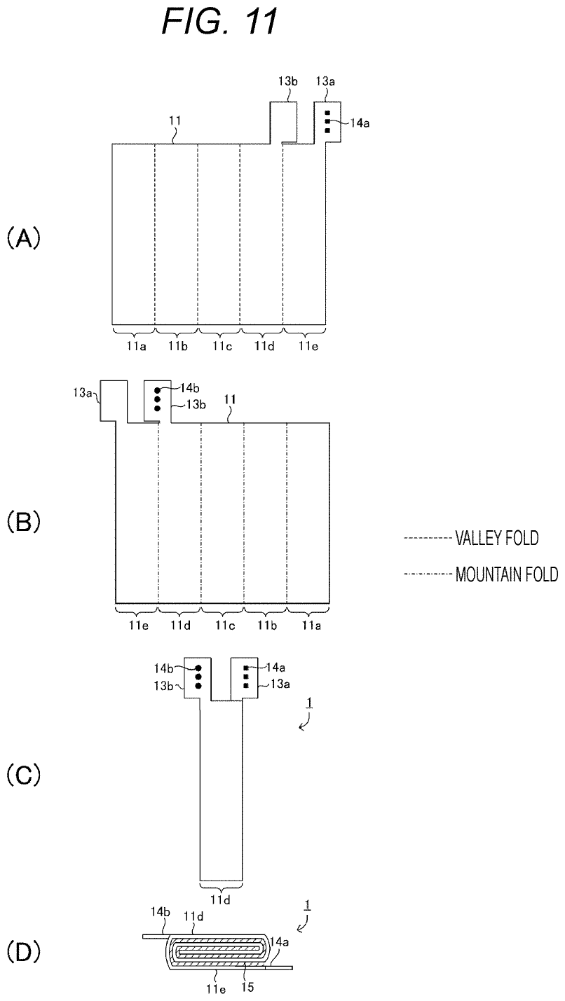

FIG. 11 is a diagram showing a manufacturing process and a structure of an audio device 1 according to a fourth embodiment. In the present embodiment, a piezoelectric sheet 11 is folded by being divided into five regions 11a to 11e, and all the folding methods are valley folds as shown in FIG. 11 (A). As a result, as shown in FIG. 11 (D), the piezoelectric sheet 11 is spirally wound similarly to the first embodiment.

Moreover, in the fourth embodiment, extension portions 13a and 13b are provided in a region 11e and a region 11d. The extension portions 13a and 13b also extend in the lateral direction. As a result, when the piezoelectric sheet 11 is folded, as shown in FIG. 11(D), the extension portions 13a and 13b extend to different sides. Therefore, it is possible to increase the areas of the extension portions 13a and 13b, and it is possible to facilitate wiring and to firmly fix the signal line by increasing the fixing area by soldering, for example. In addition, as in the third embodiment, it is also possible to provide a sufficient interval between the extension portions 13a and 13b to suppress a short circuit at the time of wiring.

### 8. Fifth Embodiment

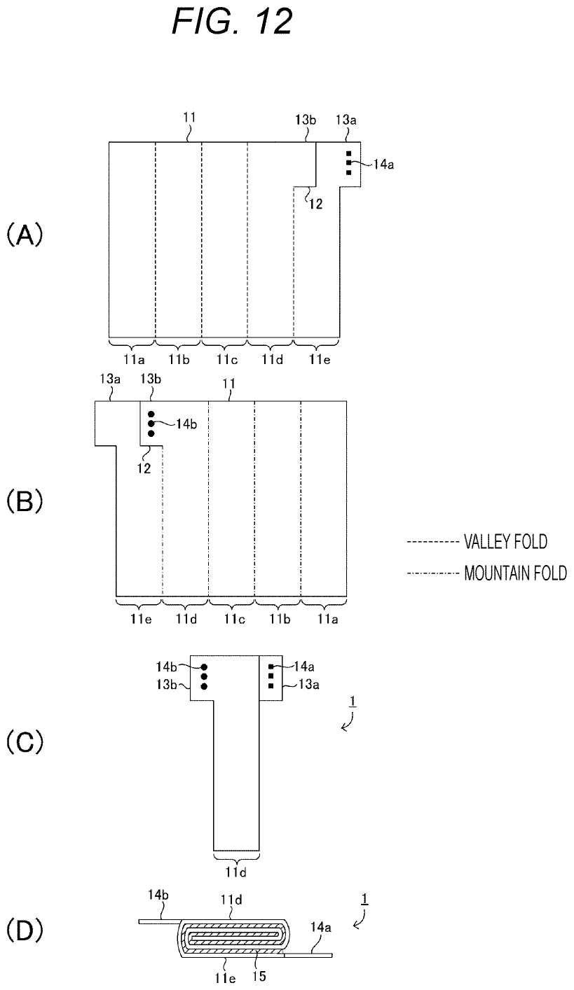

FIG. 12 is a diagram showing a manufacturing process and a structure of an audio device 1 according to a fifth embodiment. In the present embodiment, a piezoelectric sheet 11 is folded by being divided into five regions 11a to 11e, and all the folding methods are valley folds as shown in FIG. 12(A). As a result, as shown in FIG. 12(D), the piezoelectric sheet 11 is spirally wound similarly to the first embodiment.

In the fifth embodiment, extension portions 13a and 13b are provided in a region 11e and a region 11d. In particular, the extension portion 13b is provided with a cut 12 in the region 11e adjacent to the region 11d, and is formed in a form of biting into the region 11e. As a result, when the piezoelectric sheet 11 is folded, as shown in FIG. 12(D), the extension portions 13a and 13b extend to different sides, and it is possible to increase the interval between electrode portions 14a and 14b positioned on the same side of the audio device 1. Therefore, wiring of the signal lines and routing of the signal lines are facilitated. Furthermore, in the fifth embodiment, by accommodating the extension portion 13b inside the rectangular shape of the piezoelectric sheet 11, it is possible to improve the yield when the piezoelectric sheet 11 is cut out, that is, the number that can be cut out from the large-sized piezoelectric sheet 11.

According to at least one embodiment of the present disclosure, it is possible to realize suitable acoustic characteristics in an audio device or an audio reproduction apparatus using a thin film material having capacitive characteristics.

### 9. Modification Example

Although the various embodiments have been described above for the audio reproduction apparatus 4 using the audio device 1, the present invention is not limited to the described embodiments, and various modifications can be adopted. Modifications will be described below.

In the first embodiment, the adhesive layer is formed by pressing the thermoplastic sheet in a state where the thermoplastic sheet is sandwiched, but the formation of the adhesive layer is not limited to such a form using the thermoplastic sheet, and various modifications can be adopted. For example, a spray paste may be used for the adhesive layer. In a case where a spray adhesive is used, it is possible to form an adhesive layer by spraying the spray adhesive on a surface to be adhered to the piezoelectric sheet 11 and pressure-bonding the adhesive.

Moreover, as the adhesive layer, for example, a double-sided tape having adhesive layers on both surfaces of the reinforcing layer may be used. By providing the reinforcing layer, it is possible to improve the strength of the audio device 1 to be formed.

Furthermore, a double-sided tape may be used for the adhesive layer. The audio device 1 can be easily formed by pressure-bonding in a state in which the double-sided tape is sandwiched. In addition to the double-sided tape, a glue (adhesive) may be used for the adhesive layer.

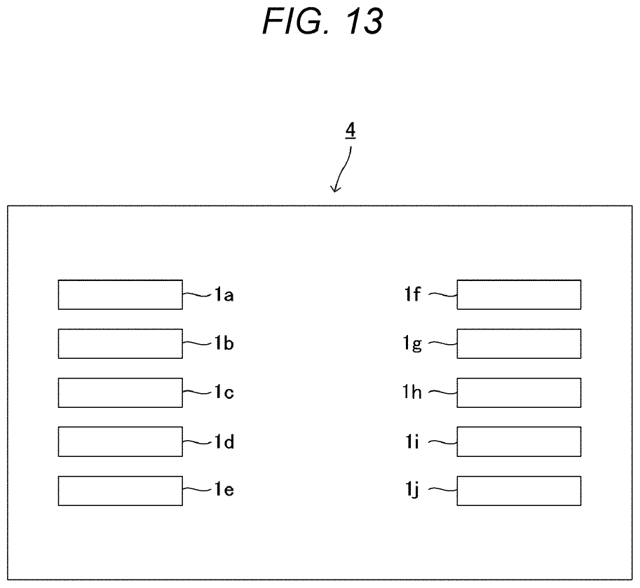

Moreover, in a case where a plurality of audio devices 1 is used in the audio reproduction apparatus 4, various forms other than the forms shown in FIGS. 5 to 8 can be adopted as disposition of the audio devices 1. FIG. 13 shows one example of disposition of audio devices 1a to 1j in the audio reproduction apparatus 4. Note that, in FIG. 13, similar to FIGS. 5 to 8, wiring to the audio devices 1a to 1j is omitted. As described above, for example, a plurality of pairs of audio devices 1a to 1j may be disposed such that the audio devices 1a and 1f are arranged side by side as a pair. In the disposition example of FIG. 13, a pair of audio devices is disposed in the vertical direction. In this manner, at the time of disposing a plurality of audio devices, the sound pressure and the acoustic characteristics suitable for the system can be adjusted depending on the disposition direction, the disposition position with respect to the vibrated portion 2, and the like in addition to the increase or decrease in the number of audio devices.

Note that the audio devices 1a to 1j used in FIG. 13 may be created in the form described in FIG. 3, for example, so that the electrode portion 14a and the electrode portion 14b face the same surface of the audio devices 1a to 1j. Alternatively, the electrode portion 14a and the electrode portion 14b may be configured to face different surfaces of the audio devices 1a to 1j.

Furthermore, for example, in the audio reproduction apparatus 4 used for comparing the frequency characteristics in FIG. 8, the plurality of audio devices 1a to 1f (Alternatively, 1g to 1l) is used for the same channel, but the areas of the audio devices 1a to 1f (Alternatively, 1g to 1l) used for the same channel may be different. Since the areas of the audio devices 1a to 1f (alternatively, 1g to 1l) are different, it is possible to make frequency characteristics different, and it is possible to realize suitable frequency characteristics as a whole.

Furthermore, the signals inputted into the audio devices 1a to 1f (alternatively, 1g to 1l) used for the same channel may be signals of which frequency is partially cut off. For example, regarding 1d and 1j having a left-right symmetrical relationship in FIG. 8, the low frequency band is blocked to obtain a high frequency channel (1d represents a left channel, and 1j represents a right channel). In this way, since the frequency bands of the signals inputted into the audio devices 1a to 1f (alternatively, 1g to 1l) are different, it is possible to realize suitable frequency characteristics as a whole. Note that, as in the above-described modification, the areas of the audio devices 1a to 1f (alternatively, 1g to 1l) may be made different from each other, and a signal partially cut off in frequency according to the areas of the audio devices 1a to 1f (alternatively, 1g to 1l) may be inputted.

The present disclosure can be similarly applied to a flexible material such as a wind-up screen such as a projector screen or a self-standing screen as the vibrated portion 2.

The present disclosure can also be similarly applied to a large screen such as a theater.

In addition, the present disclosure can be similarly applied even when there is a portion penetrating as the vibrated portion 2, such as a screen having a small through hole. It is also possible to efficiently transmit sound to the surface opposite to the surface provided with the audio device 1 via the through hole provided in the vibrated portion 2.

The present disclosure can also be realized by an apparatus, a method, a system, and the like. Moreover, the matters described in each embodiment and modification can be appropriately combined.

Note that the effects described herein are not necessarily limited, and any one of the effects described in the present disclosure may be exerted. Furthermore, the contents of the present disclosure are not to be interpreted as being limited by the exemplified effects.

The present disclosure can also adopt the following configurations.

(1)

An audio reproduction apparatus including:

an audio device in which a plurality of layer structures is formed by folding a thin film material including a first electrode layer, a second electrode layer, and a capacitance layer sandwiched between the first electrode layer and the second electrode layer a plurality of times; and

a vibrated portion which is bendable and to which one face of the audio device is fixed.

(2)

The audio reproduction apparatus according to (1), in which

one face of the audio device is fixed so as to be in close contact with the vibrated portion.

(3)

The audio reproduction apparatus according to (2), in which

one face of the audio device is fixed to the vibrated portion with an adhesive.

(4)

The audio reproduction apparatus according to any one of (1) to (3), in which

the thin film material is spirally folded to form a plurality of layer structures.

(5)

The audio reproduction apparatus according to any one of (1) to (4), in which

at the thin film material, an electrode portion is formed on each of the first electrode layer and the second electrode layer.

(6)

The audio reproduction apparatus according to (5), in which

the first electrode layer and the second electrode layer are provided on a same side in a state where the thin film material is folded a plurality of times.

(7)

The audio reproduction apparatus according to any one of (1) to (6), in which

the vibrated portion is a display panel.

(8)

The audio reproduction apparatus according to any one of (1) to (7), further including

a plurality of the audio devices.

(9)

The audio reproduction apparatus according to any one of (1) to (8), in which

a signal in which a partial frequency of an input signal is cut off is inputted into a plurality of the audio devices.

(10)

The audio reproduction apparatus according to any one of (1) to (9), in which

a plurality of the audio devices has different areas facing the vibrated portion.

(11)

An audio device, in which

a thin film material including a first electrode layer, a second electrode layer, and a capacitance layer sandwiched between the first electrode layer and the second electrode layer is folded a plurality of times to form a plurality of layer structures, and one face of the audio device is fixed to a vibrated portion which is bendable.

### REFERENCE SIGNS LIST

1 (1a to 1l) Audio device
2 Vibrated portion
4 Audio reproduction apparatus
11 Piezoelectric sheet
11a to 11e Region
12 Cut
13a, 13b Extension portion
14a, 14b Electrode portion
15 (15a to 15d) Adhesive layer
21a, 21b Signal line
22a, 22b Signal line

1. An audio reproduction apparatus comprising:
an audio device in which a plurality of layer structures is formed by folding a thin film material including a first electrode layer, a second electrode layer, and a capacitance layer sandwiched between the first electrode layer and the second electrode layer a plurality of times; and
a vibrated portion which is bendable and to which one face of the audio device is fixed.

2. The audio reproduction apparatus according to claim 1, wherein
one face of the audio device is fixed so as to be in close contact with the vibrated portion.

3. The audio reproduction apparatus according to claim 2, wherein
one face of the audio device is fixed to the vibrated portion with an adhesive.

4. The audio reproduction apparatus according to claim 1, wherein
the thin film material is spirally folded to form a plurality of layer structures.

5. The audio reproduction apparatus according to claim 1, wherein
at the thin film material, an electrode portion is formed on each of the first electrode layer and the second electrode layer.

6. The audio reproduction apparatus according to claim 5, wherein
the first electrode layer and the second electrode layer are provided on a same side in a state where the thin film material is folded a plurality of times.

7. The audio reproduction apparatus according to claim 1, wherein
the vibrated portion is a display panel.

8. The audio reproduction apparatus according to claim 1, further comprising
a plurality of the audio devices.

9. The audio reproduction apparatus according to claim 1, wherein
a signal in which a partial frequency of an input signal is cut off is inputted into a plurality of the audio devices.

10. The audio reproduction apparatus according to claim 1, wherein
a plurality of the audio devices has different areas facing the vibrated portion.

11. An audio device, wherein
a thin film material including a first electrode layer, a second electrode layer, and a capacitance layer sandwiched between the first electrode layer and the second electrode layer is folded a plurality of times to form a plurality of layer structures, and one face of the audio device is fixed to a vibrated portion which is bendable.
